(19) United States
(12) Patent Application Publication
(10) Pub. No.: US 2004/0013787 A1
(43) Pub. Date: Jan. 22, 2004

(54) Fat compositions for infant formula and methods therefor

(76) Inventor: Richard C. Theuer, Raleigh, NC (US)

Correspondence Address: Donald R. Holland, Harness, Dickey & Pierce, P.L.C., Suite 400, 7700 Bonhomme Avenue, St. Louis, MO, 63105, US

(21) Appl. No.: 10/464,375

(22) Filed: Jun. 18, 2003

Related U.S. Application Data
(60) Provisional application No. 60/392,097, filed on Jun. 28, 2002.
(60) Provisional application No. 60/404,896, filed on Aug. 21, 2002.

(51) Int. Cl. A23D 7/00

(52) U.S. Cl. 426/601

(57) ABSTRACT

Fat compositions and infant formulas containing oleic acid in an amount of at least about 50% by weight of total fatty acids, lauric acid in an amount of at least about 10% by weight, palmitic acid in an amount of not more than about 10% by weight and, in certain embodiments, linoleic acid in an amount of not more than about 16% by weight. The fat compositions can be prepared to contain one or more oleic acid oils in a total amount of at least about 50% by weight, one or more linoleic acid oils in a total amount of not more than about 18% by weight and, in certain embodiments, one or more lauric acid oils in an amount of at least about 20% by weight. Also disclosed are methods of making the fat compositions and infant formulas and methods for providing a fat component to infant diets.

### CROSS REFERENCE TO RELATED APPLICATIONS

This application claims priority to U.S. Provisional Patent Application No. 60/392,097, filed Jun. 28, 2002 and U.S. Provisional Patent Application No. 60/404,896, filed Aug. 21, 2002, both of which are incorporated in their entireties by reference.

### BACKGROUND

(1) Field

This invention is related generally to food products containing fat or oil and, more particularly to fat compositions useful for incorporation into infant formula and to infant formulas containing such fat compositions as well as to methods of feeding infants using such formulas.

(2) Related Art

Infant formulas are intended for use as a substitute for breast milk in meeting the normal nutritional requirements of infants. (Codex Standard for Infant Formula CODEX STAN 72-1981 in Codex Alimentarius, Vol. 4, pp. 16-23, Food and Agriculture Organization of the United Nations—World Health Organization. Rome, 1994). Typically, liquid infant formulas constitute the sole item of diet for infants which are not breast fed. The essential components of infant formulas include vitamins, minerals, choline, protein, carbohydrate, and fat (Id.).

The fat component of infant formulas has traditionally been considered the most important energy source for the infant as well as a necessary requirement for normal growth and development. (Uauy et al, Am. J. Clin. Nutr. 72(suppl): 1354S-60S, 2000). The Codex Standard established for the amount of fat in an infant formula is not less than 3.3 grams and not more than 6 grams per 100 available kilocalories (Codex Standard for Infant Formula, supra, 1994). Fat provides approximately 9 kilocalories per gram. Consequently, fat contributes between 30 percent and 54 percent of available kilocalories in an infant formula. In most commercial infant formulas, fat provides about half of the food energy.

An infant formula may contain a single vegetable oil such as soy oil or corn oil as the source of virtually all the fat in the formula. More commonly, infant formulas contain a mixture of fat ingredients, commonly described by those skilled in the art as a “fat blend,” as the source of added fat. Fat blends used in the preparation of infant formulas include vegetable oils that have been characterized as lauric acid oils, palmitic acid oil, oleic acid oils and linoleic acid oils because the predominant component of the oil is lauric acid, palmitic acid, oleic acid, or linoleic acid, respectively (Theuer, U.S. Pat. No. 4,282,265, 1981). Lauric acid oils include coconut oil, babassu oil and palm kernel oil; palmitic acid oil includes palm oil; oleic acid oils include oleic oil and olive oil; and linoleic acid oils include corn oil, soybean oil, sunflower seed oil and safflower oil. Animal fats are also sometimes included in infant formulas such as, for example, oleo oil or beef fat (Bernhart, U.S. Pat. No. 3,649,295, 1972).

Although many infant formulas have been devised, most of those previously disclosed contain predominantly oleic acid oils, the maximum amount of which can be up to 45% of the fat composition (Bernhart, U.S. Pat. No. 3,649,295, 1972; Theuer, U.S. Pat. No. 4,282,265, 1981; Rule, U.S. Pat. No. 4,614,663, 1986; Tomarelli, U.S. Pat. No. 5,000,975, 1987; Lien et al., U.S. Pat. No. 5,601,860, 1997). Kuchan et al. describe a fat composition which could have higher levels of 35-55% by weight high oleic safflower oil (Kuchan et al., U.S. Pat. No. 6,248,784, 2001). The infant compositions disclosed by Kuchan et al. also contained relatively high levels of the linoleic acid oil, soy oil in an amount of 20-40% by weight.

Infant formulas, have also been reported which contain high levels of palmitic acid oils or lauric acid oils in which the minimum amount of one of the two oils is 20% or greater by weight (Theuer, U.S. Pat. No. 4,282,265, 1981; Rule, U.S. Pat. No. 4,614,663, 1986; Kuchan et al., U.S. Pat. No. 6,248,784).

The fatty acid distributions of infant formulas differ. However many infant formulas in which the fatty acid distribution has been determined, contain maximum amounts of oleic acid up to 48% by weight (Theuer, U.S. Pat. No. 4,282,265, 1981; Rule, U.S. Pat. No. 4,614,663, 1986; Tomarelli, U.S. Pat. No. 5,000,975, 1987; Lien et al., U.S. Pat. No. 5,601,860, 1997; Wang et al. U.S. Pat. No. 6,034,130, 2000; Kuchan et al. U.S. Pat. No. 6,248,784, 2001). In addition, some infant formulas have been reported to contain palmitic acid in minimum amounts of at least 11% or greater (Rule, U.S. Pat. No. 4,614,663, 1986; Theuer, U.S. Pat. No. 4,282,265, 1981; Tomarelli, U.S. Pat. No. 5,000,975, 1987; Lien et al., U.S. Pat. No. 5,601,860, 1997; Wang et al. U.S. Pat. No. 6,034,130, 2000;); lauric acid in minimum amounts of at least 9.5% or greater (Kuchan, U.S. Pat. No. 6,248,784, 2001) and/or linoleic acid in minimum amounts of at least 18% or greater (Rule, U.S. Pat. No. 4,614,663, 1986; Kuchan et al., U.S. Pat. No. 6,248,784, 2001).

The fatty acids in infant formulas are primarily those fatty acids found in human breast milk, i.e. oleic acid, lauric acid, palmitic acid and linoleic acid (see Theuer, U.S. Pat. No. 4,282,265, 1980; Fomon in Nutrition of Normal Infants Mosby-Year Book, Inc., St. Louis, 1993; p. 154-156). Although infant formulas generally contain the fatty acids found in human breast milk, nevertheless, the profile of the relative amounts of these fatty acids may differ from that in human breast milk. This difference can sometimes allow the formula to exhibit characteristics that are functionally similar to breast milk. For example, Kuchan et al. (U.S. Pat. No. 6,248,784, 2001) have reported that in order to attain stool patterns similar to that of breast-fed infants, an infant formula should contain a fat component that is less than 10% by weight palmitic acid. This is because triglycerides from most animal and vegetable fats contain palmitic acid that is primarily in the sn-1 and sn-3 positions compared to the sn-2 position in human milk. But pancreatic lipase hydrolyzes the fatty acids of the sn-1 and sn-3 positions but not the sn-2 position to yield two free fatty acids and a 2-monoglyceride. The free fatty acids then form fatty acid soaps which are lost in the feces. As a result, the palmitic acid is poorly absorbed and the infant stools become firmer and less frequent (Lien, J. Pediatrics 125:S62-S68, 1994; Motil, Current Opinion in Pediatrics 12:469-476, 2000).

In addition to the effect of palmitic acid on stools and fatty acid absorption, other fatty acids used in infant formulas are known or postulated to affect the health and well being of the infant. For example, lauric acid which is a saturated fatty acid, has been suggested to have a high atherogenic potential which is undesirable whereas an infant diet enriched with the monosaturated fatty acid, oleic acid, has been suggested to help keep the lipoprotein profile in the infant similar to that achieved during breast feeding only (Giovannini et al, The Journal of International Medical Research 19:351-361, 1991).

The polyunsaturated fatty acid, linoleic acid, is the parent fatty acid of the n-6 family of polyunsaturated fatty acids. These fatty acids are precursors of biologically active eicosanoids and high dietary levels of the fatty acid may influence the production of eicosanoids in ways that could be undesirable (Carroll, J. Nutr 119:1810-1813, 1989). In addition, polyunsaturated fatty acids are susceptible to autooxidation and there is continuing concern over the biological effects of the oxidative products (Id.; Hassan et al., Am. J. Clin Nutr 19:147-157). As a result, it has been recommended that n-6 fatty acids should not exceed 20% of total fatty acid or 10% of total energy in standard infant formulas (Carroll, supra, 1989; Widdowson, J. Nutr 119:1814-1816, 1989).

The above possible deleterious and beneficial effects of the fatty acids have not been fully taken into account in the design of prior infant formula preparations, mainly because it has not been heretofore appreciated that infant formulas can contain amounts of oleic acid of 50% or greater so as to avoid undesirable effects of lauric acid, palmitic acid and linoleic acid. Thus there remains a continuing need for improved fatty acid compositions for infant formulas which can provide the nutritional benefits as well as provide for the growth and development of the infant without diminishing the health or well being of the infant.

### BRIEF DESCRIPTION

Accordingly, the inventor herein has succeeded in devising fatty acid components for infant formulas which contain high levels of oleic acid and relatively low levels of lauric acid, palmitic acid and linoleic acid. One component of the infant formulas of the present invention is one or more high oleic acid oils, i.e. oils which contain high levels of oleic acid. The presence of high levels of oleic acid in the new infant formulas allows the levels of palmitic acid and linoleic acid to be reduced compared to earlier infant formulas without substantially increasing the lauric acid component.

Thus, in various embodiments, the present invention can comprise a fat composition suitable for use in an infant formula. The fat composition comprises (a) oleic acid in an amount of at least about 50% by weight of total fatty acids; (b) lauric acid in an amount of at least about 10% by weight of total fatty acids; and (c) palmitic acid in an amount of not more than about 10% by weight of total fatty acids.

The present invention, in various embodiments, can also comprise a substantially vegetable fat composition comprising (a) oleic acid in an amount of at least about 50% by weight of total fatty acids and (b) lauric acid in an amount of at least about 10% by weight of total fatty acids. In various embodiments, the substantially vegetable fat composition can further comprise palmitic acid in an amount of not more than about 10% by weight of total fatty acids.

In various embodiments, the present invention can also comprise a fat composition comprising at least (a) one or more oleic acid oils wherein the total amount oleic acid oils is at least about 50% by weight and, optionally, (b) one or more linoleic acid oils wherein the total amount of linoleic acid oils is from 0 to about 18% by weight. In certain embodiments, the fat composition can also comprise one or more lauric acid oils in a total amount of at least about 20%.

The oleic acid oils can be high oleic safflower oil, high oleic sunflower oil, mid-oleic sunflower oil, olive oil, canola oil, high oleic canola oil, high oleic low linolenic acid canola oil, high oleic soybean oil, or combinations thereof.

The lauric acid oils can be coconut oil, palm kernel oil, babassu oil, cuphea oil, or combinations thereof.

The linoleic acid oils can be soybean oil, corn oil, sunflower oil, safflower oil, linola oil, or combinations thereof.

The fat composition, in various embodiments, can be in an acceptable infant food preparation. In various embodiments, the fat composition of the present invention can also include linoleic acid in an amount of at least about 5% and not more than about 16% by weight, linolenic acid in an amount of at least about 0.5% and not more than about 3.5% by weight, docosahexaenoic acid when present in an amount of from 0-2%, preferably, at least about 0.2% and not more than about 2% by weight, and arachidonic acid in an amount of from 0-4%, preferably, at least about 0.4% and not more than about 2% by weight when present.

In various embodiments, the present invention is also directed to an infant formula comprising the above fatty acids. The infant formula can be in a liquid form or in powder form for reconstitution upon addition of an aqueous liquid.

In addition to the fatty acid component, the infant formula can include a protein component, a carbohydrate component and one or more of a component selected from the group consisting of a vitamin, a mineral or electrolyte, choline chloride, inositol, taurine, a nucleotide, and combinations, thereof. The protein can be of bovine milk origin or vegetable origin. The protein from bovine milk can, in certain embodiments, be selected from the group consisting of skim milk, demineralized whey, whey protein concentrate, hydrolyzed milk proteins, lactic peptides and mixtures thereof. The protein of vegetable origin can, in certain embodiments, be soy protein.

The carbohydrate component can be, in certain embodiments, a carbohydrate selected from the group consisting of monosaccharides, disaccharides, oligosaccharides, polysaccharides and combinations thereof.

The vitamin can, in certain embodiments, be one or more of a component selected from the group consisting of vitamin A, vitamin D, vitamin E, Vitamin C, Folic Acid, Thiamine, Riboflavin, Niacin, Vitamin B₆, Vitamin B₁₂, Biotin, Pantothenic Acid, Vitamin K, and combinations thereof.

The mineral or electrolyte component can, in certain embodiments, be a component selected from the group consisting of calcium, sodium, potassium, phosphorus, iron, magnesium, copper, zinc, manganese, selenium, iodine, chloride, and combinations thereof.

The present invention, in various embodiments, is also directed to methods of making the fat compositions and infant formulas described above. In various embodiments, the method comprises combining three or more fatty acid oils to produce a mixture comprising (a) oleic acid in an amount of at least about 50% by weight of total fatty acids; (b) lauric acid in an amount of at least about 10% by weight of total fatty acids; and (c) palmitic acid in an amount of not more than about 10% by weight of total fatty acids.

In still other embodiments, the method can comprise making a substantially vegetable fat composition by combining three or more fatty acid oils to produce a mixture comprising (a) oleic acid in an amount of at least about 50% by weight of total fatty acids and (b) lauric acid in an amount of at least about 10% by weight of total fatty acids. In addition, in various embodiments, the mixture can include palmitic acid in an amount of not more than about 10% by weight of total fatty acids.

In various embodiments, the method can comprise combining in a mixture (a) one or more oleic acid oils in an amount of at least about 50% by weight and (b) one or more linoleic acid oils in an amount of not more than about 18% by weight. In addition, in various embodiments, the method can further comprising adding to the mixture one or more lauric acid oils in a total amount of at least about 20%.

In various embodiments, the methods of the present invention can involve the preparation of infant formulas by combining the fat compositions with one or more protein sources, one or more carbohydrates and one or more of a component selected from the group consisting of a vitamin, a mineral or electrolyte, choline chloride, inositol, taurine, a nucleotide, and combinations thereof.

The present invention, in various embodiments, can be directed to a method for providing a fat component to an infant's diet. The method comprises feeding to the infant a formula comprising one of the fat compositions of the present invention.

### DETAILED DESCRIPTION

The fat compositions in various embodiments of the present invention can contain amounts of oleic acid of 50% or greater of the total fat composition by weight and, in addition, lauric acid in an amount of at least about 10%, palmitic acid in an amount of not more than about 10% and, in certain embodiments, linoleic acid in an amount of not more than about 16%. The high level of oleic acid can be achieved, in various embodiments, by forming a mixture containing one or more oleic acid oils in a total amount of 50% or greater of the total fat composition by weight.

In various embodiments, this can be achieved by using substantially vegetable oils in the mixture forming the fat composition. Oleo oil, i.e. oil obtained from beef fat has been used in some infant formulas (see for example Berrhart, U.S. Pat. No. 3,649,295, 1972; Berrhart, U.S. Pat. No. 2,611,706). However, the use of animal fat has been viewed as less than ideal (see for example Theuer, U.S. Pat. No. 4,282,264, 1981). Thus, in certain embodiments, it can be desirable to minimize the amount of animal fat. As used herein, the term “substantially vegetable fat” is intended to mean less than 10% oleo oil, preferably, less than 5% oleo oil and, preferably, less than 2% oleo oil by weight. The term “substantially free of animal fat” is intended to mean less than 10%, preferably, less than 5% and, preferably, less than 2% by weight, animal fat of any origin. Nevertheless, fat compositions that are substantially vegetable fat, fat compositions that are substantially free of animal fat, and fat compositions that contain animal fat or fat from fish products in greater amounts are all within the scope of the present invention, so long as the oleic acid content or the oleic acid oil content of the fat composition is 50% or greater by weight.

Edible fats or oils are foodstuffs which are composed primarily of glycerides of fatty acids. They may contain small amounts of other lipids such as phosphatides, of unsaponifiable constituents and of free fatty acids naturally present in the fat or oil.

The term “fatty acid oils” as used herein is intended to mean the fat components which can make up infant formulas such as, for example, vegetable oils such as oleic acid oils, lauric acid oils, palmitic acid oil, and/or linoleic acid oils as well as animal fats such as, for example, oleo oil or beef fat. In particular, the fatty acid oils can include, for example, arachis oil (peanut oil or groundnut oil), babassu oil, coconut oil, cottonseed oil, grapeseed oil, maize oil (corn oil), mustardseed oil, palm kernel oil, palm oil, palm olein, palm stearin, rapeseed oil—low erucic acid (low erucic acid turnip rape oil, low erucic acid colza oil, or canola oil), safflowerseed oil (safflower oil, carthamus oil, or kurdee oil), safflowerseed oil—high oleic acid (high oleic acid safflower oil, high oleic acid carthamus oil, or high oleic acid kurdee oil), sesameseed oil (sesame oil, gingelly oil, benne oil, ben oil, till oil, or tillie oil), soya bean oil (soybean oil), sunflowerseed oil (sunflower oil), sunflowerseed oil—high oleic acid (high oleic acid sunflower oil), and any other edible oil so long as the oil is suitable for use in an infant formula.

The fatty acid components of the present invention, such as, for example, oleic acid, lauric acid, palmitic acid, linoleic acid, linolenic acid, and docosahexaenoic acid and arachidonic acid can be in the form of free fatty acids or as a triglyceride containing the fatty acid in the sn-1, sn-2 or sn-3 positions or in any other fatty acid source that releases the fatty acid upon ingestion and metabolism of the fatty acid source by an infant.

The fat compositions of the present invention can be in an acceptable infant food preparation. In certain instances, the oil components mixed to form the fat composition of the present invention will need to have been refined to deodorize or decolorize the oil containing the fatty acid and thereby produce a form that is organoleptically acceptable to the baby and to the caregiver. Various methods for refining food oils are known in the art (see for example, Mamoru et al., Japanese Application No. JP-03-244344, 1991). In addition, the oil can contain high levels of acid which may need to be neutralized during refining.

An infant formula fat blend may encompass combinations of specific named oils or, alternatively, combinations of specified oil classes, such as oleic acid oils, lauric acid oils, and the like. An infant formula fat blend may additionally encompass specific distributions of individual fatty acids referenced herein by the terms “fatty acid profile” and “fatty acid distribution,” which are used interchangeably herein. The levels of individual fatty acids in a fatty acid profile are commonly expressed as percentages by weight of total fatty acids in the fat component of an infant formula.

Oleic acid oils and linoleic acid oils are vegetable oils wherein unsaturated fatty acids constitute in excess of 75% by weight of the total fatty acids. Unsaturated fatty acids comprise monounsaturated fatty acids such as palmitoleic acid and oleic acid and polyunsaturated fatty acids such as linoleic acid and alpha-linolenic acid.

Oleic acid oils are defined herein as vegetable oils wherein unsaturated fatty acids constitute in excess of 75% by weight of the total fatty acids and wherein oleic acid constitutes not less than 50% by weight of total unsaturated fatty acids. Reported fatty acid distributions of some representative commercially important oleic acid oils are shown in Table 1A. Reported fatty acid distributions of some newer oleic acid oils are shown in Table 1B.

TABLE 1A
Fatty acid profiles of commercially important oleic acid oils.

| | | | High oleic | High oleic | |
|---|---|---|---|---|---|
| fatty acid | | Olive oil | safflower oil | sunflower oil | Canola oil |
| Palmitic | 16:0 | 13% | 5% | 4% | 4% |
| acid | | | | | |
| Stearic | 18:0 | 3% | 2% | 4% | 2% |
| acid | | | | | |
| Total | | ˜16% | ˜7% | ˜8% | ˜6% |
| saturated | | | | | |
| Oleic acid | 18:1w9 | 71% | 75% | 80% | 63% |
| Linoleic | 18:2w6 | 10% | 17% | 10% | 20% |
| acid | | | | | |
| Linolenic | 18:3w3 | 1% | 0.4% | 0.1% | 8.6% |
| acid | | | | | |
| Total | | ˜82% | ˜92% | ˜90% | ˜94% |
| unsatu- | | | | | |
| rated | | | | | |

| | | | | |
|---|---|---|---|---|
| Oleic as % of total | ˜85% | ˜81% | ˜89% | ˜67% |
| unsat. | | | | |

High oleic safflower oil and high oleic sunflower oil are well known to those skilled in the art. See, for example, Bernhart (U.S. Pat. No. 3,649,295) and Kuchan et al. (U.S. Pat. No. 6,248,784).

Canola oil is low erucic acid rapeseed oil. The identity specification for low erucic acid rapeseed oil in U.S. regulation (21 CFR 184.1555(c)(1)) stipulates that, chemically, the oil is a mixture of triglycerides, composed of both saturated and unsaturated fatty acids, with an erucic acid content of not more than 2 percent of the component fatty acids.

TABLE 1B
Fatty acid profiles of some newer oleic acid oils.

| | | | | High oleic, | Mid oleic |
|---|---|---|---|---|---|
| | | High oleic | High oleic | low linolenic | sunflower |
| Fatty acid | | soybean oil | canola oil | canola oil | oil |
| Palmitic | 16:0 | 6.6 | 5% | 5% | 4% |
| acid | | | | | |
| Stearic | 18:0 | 3.4 | 2% | 2% | 5% |
| acid | | | | | |
| Total | | ˜10% | ˜7% | ˜7% | ˜9% |
| saturated | | | | | |
| Oleic acid | 18:1w9 | 83.8% | 78% | 84% | 60% |
| Linoleic | 18:2w6 | 2.2% | 8% | 5% | 30% |
| acid | | | | | |
| Linolenic | 18:3w3 | 3.5% | 6% | 3% | 0.1% |
| acid | | | | | |
| Total | | ˜90% | ˜92% | ˜92% | ˜90% |
| unsatu- | | | | | |
| rated | | | | | |

| | | | | |
|---|---|---|---|---|
| Oleic as % of total | ˜93% | ˜81% | ˜90% | ˜67% |
| unsat. | | | | |

High oleic soybean oil is the oil produced from soybeans genetically engineered to incorporate the GmFad2-1 gene to suppress endogenous GmFad2-1 gene, which encodes delta-12 desaturase. The extra genes work by silencing an existing gene, and so reducing the conversion of mono-unsaturated oleic acid to polyunsaturated oils. High oleic soybean oil was the subject of an FDA letter dated Mar. 14, 1997 and an FDA memorandum dated Dec. 5, 1996.

High oleic canola oil originates from the 46A12 and 46A16 lines of canola (Brassica napus), which were developed through the combination of chemical mutagenesis, to achieve the high oleic acid trait, and traditional breeding with registered canola varieties. Line 46A12 was derived from a single plant resulting from a cross between the high oleic acid parent, NS699, and NS1172, a broad-based spring canola population originating from European germplasm. Line 46A16 was derived from a cross between the high oleic acid parent, NS672, and NS1167, a broad-based population originating from Canadian germplasm. The processed oil derived from these novel varieties has levels of oleic acid similar to that of peanut and olive oils. High oleic canola oil, identified as “HOCAN,” is available from Intermountain, Idaho Falls, Id., USA) with a fatty acid content of approximately 74% oleic acid, 9% linoleic acid, and 7% linolenic acid. Refined, bleached and deodorized high oleic canola oil, identified as “HOCO,” can be obtained from Anderson Clayton/Humko, Memphis, Tenn., with a fatty acid content of approximately 75% oleic acid, 8% linoleic acid, and 5-6% linolenic acid.

High oleic, low linolenic canola oil originates from the 45A37 and 46A40 lines of canola (Brassica napus), which were developed through the combination of chemical mutagenesis, to achieve the high oleic acid trait, and traditional breeding with the registered canola varieties Stellar and Apollo, to achieve the low linolenic acid trait. The processed oil derived from these novel varieties, designated P6 canola oil in Canada, has levels of oleic acid similar to that of peanut and olive oils. High oleic, low linolenic canola oil, identified as “HOLLCAN,” is available from Intermountain, Idaho Falls, Id., USA. It contains approximately 75-78% oleic acid, 11-13% linoleic acid and 2-3% linolenic acid.

The high oleic acid trait in lines 46A12, 46A16, 45A37, and 46A40 was selected following chemical mutagenesis by exposing seeds of canola varieties Regent, Topas and Andor to a solution of ethylnitrosourea (8 mM) in dimethylsulfoxide. Ethylnitrosourea is a commonly used chemical mutagen that affects DNA by chemically altering base pairs. It is believed that the induced mutation in lines 46A12, 46A16, 45A37, and 46A40 is analogous to that in fad2 mutants of Arabidopsis thaliana. The fad2 gene encodes a desaturase enzyme that catalyzes the conversion of C18:1 to C18:2 and C18:3 fatty acids in plant cells. A mutation within the fad2 gene that blocks expression of an active desaturase enzyme results in the accumulation of C18:1 oleic acid at the expense of linoleic acid and linolenic acid production. The present invention contemplates the use of new sources of oleic acid oils that may be developed through the genetic manipulation of vegetables and oil-bearing plants.

Mid-oleic sunflower oil, identified as “NuSun™ oil,” was made available to the commercial market in December 1998. It is lower in saturated fat (less than 10%) than traditional sunflower oil and has higher oleic acid levels (between 50-70%) with a goal of 65% oleic acid or higher, with the balance consisting of linoleic acid.

Linoleic acid oils are defined herein as vegetable oils wherein unsaturated fatty acids constitute in excess of 75% by weight of the total fatty acids and wherein linoleic acid constitutes not less than 50% by weight of total unsaturated fatty acids. Reported fatty acid distributions of some representative commercially important linoleic acid oils are shown in Table 2. Linolenic acid as used herein refers to alpha-linolenic acid, the 18-carbon omega-3 fatty acid. Linola is a new form of linseed produced through conventional plant breeding. It yields a high quality polyunsaturated edible oil with low levels of linolenic acid and high levels of linoleic acid.

TABLE 2
Fatty acid profiles of some commercial linoleic acid oils.

| | | Corn | Soybean | Sunflower | Safflower | Linola |
|---|---|---|---|---|---|---|
| Fatty acid | | oil | oil | oil | oil | oil |
| Palmitic | 16:0 | 11% | 11% | 7% | 7% | 6% |
| acid | | | | | | |
| Stearic | 18:0 | 2% | 4% | 5% | 2% | 4% |
| acid | | | | | | |
| Total | | ˜13% | ˜15% | ˜13% | ˜9% | ˜10% |
| saturated | | | | | | |
| Oleic acid | 18:1w9 | 29% | 23% | 20% | 13% | 16% |
| Linoleic | 18:2w6 | 57% | 54% | 66% | 78% | 72% |
| acid | | | | | | |
| Linolenic | 18:3w3 | 1% | 7.6% | 0.1% | — | 2% |
| acid | | | | | | |
| Total | | ˜86% | ˜84% | ˜86% | ˜90% | ˜90% |
| unsatu- | | | | | | |
| rated | | | | | | |
| Linoleic | | ˜65% | ˜64% | ˜77% | ˜86% | ˜80% |
| acid as % | | | | | | |
| of total | | | | | | |
| unsat. | | | | | | |

Lauric acid oils are defined herein as highly saturated vegetable oils wherein the 12-carbon saturated fatty acid lauric acid constitutes 40% to 50% by weight of the total fatty acids. Unsaturated fatty acids constitute at most about 20% of total fatty acids in lauric acid oils. The most common lauric acid oils are coconut oil and palm kernel oil. A commercially less important lauric acid oil is babassu oil, the oil derived from Orbignya species. Another lauric acid oil is the oil extracted from the seed of certain Cuphea species.

Oleic acid is the predominant fatty acid in human milk in all but extremely unusual circumstances. Human milk lipid contains 25% to 46% by weight of total fatty acids as oleic acid. Infant formula fat blends disclosed in earlier references that designate a range of oleic acid content, specify a maximum amount of 48% or less as shown in Table 3.

TABLE 3
Oleic acid ranges in infant formula fat blends disclosed in the earlier
references.

| Oleic acid, % by weight | Inventor | Citation |
|---|---|---|
| 28%-46% | Theuer | U.S. Pat. No. 4,282,265 |
| 28%-44% | Rule | U.S. Pat. No. 4,721,626 |
| 30%-45% | Tomarelli et al. | U.S. Pat. No. 5,000,975 |
| 30%-43% | Lien et al. | U.S. Pat. No. 5,601,860 |
| 30%-45% | Wang et al. | U.S. Pat. No. 6,034,130 |
| 34%-48% | Kuchan et al. | U.S. Pat. No. 6,248,784 |

The fat composition of the present invention comprises not less than 10% by weight of the total fatty acids as lauric acid. Lauric acid is well-absorbed by the infant. Laurie acid is present in human milk at levels of about 5% to about 9% by weight of the total fatty acids. Fat blends disclosed earlier provide a diverse range of lauric acid levels from less than 5% by weight (Bernhart et al., U.S. Pat. No. 2,611,706, 1972) up to 18 % by weight (Tomarelli, U.S. Pat. No. 5,000,975, 1991).

The current invention is directed to a mixture of oils characterized in that it contains, by weight of total fatty acids, an amount of palmitic acid such that the amount of palmitic acid in the sn-1 and sn-3 positions of the triglycerides in the fat blend does not exceed the amount of palmitic acid found in the sn-1 and sn-3 positions of the triglycerides in human milk fat. The present invention provides a fat blend with an amount of palmitic acid of not more than 10% by weight of total fatty acids.

Unabsorbed fat is present in the stool primarily as the calcium soaps of saturated fatty acids (Quinlan et al., J. Pediatr. Gastroenterol. Nutr. 20(1): 81-90, 1995). Palmitic acid soaps account for over 50% of the stool soaps; stearic acid soaps account for almost 20%. Calcium soaps in the stool lead to firmer stools and a higher incidence of constipation. Infants fed a fat blend with little unabsorbed palmitic acid have less firm stools that are closer in consistency to the looser stools of breast-fed infants. Kuchan et al. (U.S. Pat. No. 6,248,784, 2001) disclose that an improved level of tolerance can be achieved by including in an infant formula a fat blend providing up to 10% palmitic acid.

Oils and fats containing polyunsaturated fatty acids are included in infant formula to provide the essential fatty acids required by the infant. Dietary linoleic acid is converted in the body to arachidonic acid (ARA), a biologically essential longer chain polyunsaturated omega-6 fatty acid. Dietary linolenic acid is converted in the body to docosahexaenoic acid (DHA), a biologically essential longer chain polyunsaturated omega-3 fatty acid. The metabolism of the infant is not sufficiently mature to convert these dietary fatty acids to the corresponding biologically essential longer chain polyunsaturated fatty acid. Accordingly, it is known to those skilled in the art that dietary sources of ARA and DHA are necessary for normal mental and visual development of the human infant. See, for example, Birch et al. (Birch et al. Dev Med Child Neurol.;42:174-81, 2000).

Linoleic acid is the only dietary essential fatty acid recognized in the Codex Standard. Linoleic acid is an omega-6 polyunsaturated fatty acid. The milk fat from lactating women contained from about 6% to 16% linoleic acid by weight of the total fatty acids in a survey done in 1980 (Theuer, U.S. Pat. No. 4,282,265, 1981). Fomon (Nutrition of Normal Infants. Mosby: St. Louis, 1993; p. 166) reports that linoleic acid accounted for 8.8% to 28.8% by weight of total fatty acids in the human milk lipid analyses reported between 1985 and 1989. Sauerwald et al. (Lipids 36(9):991-996, 2001) commented that the content of linoleic acid in human milk has doubled in the past few decades.

Considerable attention has been given lately to the appropriate ratio of omega-3 to omega-6 fatty acids in the human diet. The ratio in human milk is influenced by diet. Over the past century the amounts of omega-3 fatty acids in the diet have fallen and the amounts of omega-6 fatty acids have risen, related to increased consumption of refined vegetable oils high in linoleic acid, intensively reared meat and eggs, and processed foods low in omega-3 fatty acids and containing trans-fatty acids, and less consumption of fish, a food rich in omega-3 fatty acids.

A more appropriate maximum amount of linoleic acid in an infant formula fat blend may be 14% to 16% by weight of total fatty acids, essentially half the value of what was reported for 1985-1989 breast milk fat and more similar to the maximum amounts reported earlier.

The Codex Standard heretofore described requires an infant formula to contain fat at a level not less than 3.3 grams and not more than 6 grams per 100 available kilocalories and to contain linoleate at a level not less than 300 milligrams (0.3 grams) per 100 available kilocalories. Providing the linoleate requirement in an infant formula containing 6 grams of fat per 100 available kilocalories requires the infant formula fat blend to contain not less than 5% by weight of total fatty acids as linoleic acid.

The fat compositions of present invention can provide meaningful amounts of the important fatty acids as linoleic acid, i.e. in an amount by weight of total fatty acids of not less than 5% and not more than 16%.

Linolenic acid accounts for 0.3% to 2.8% by weight of the total fatty acids in the human milk fat analyses reported between 1985 and 1989. Accordingly, the present invention can provide, in various embodiments, a fat blend containing total fatty acids as linolenic acid of not less than 0.5% and not more than 3.5% by weight.

The ratio of linoleic acid (an omega-6 fatty acid) to linolenic acid (an omega-3 fatty acid) in human milk currently is about 10:1 in industrialized countries (Sauerwald et al., Polyunsaturated fatty acid supply with human milk. Lipids 36(9):991-996, 2001). The present invention can provide, in various embodiments, amounts of linoleic acid and linolenic acid sufficient to provide a linoleic acid to linolenic acid ratio of from about 4:1 and to about 14: 1, more preferably, a slightly higher range of ratios of from about 5:1 and to about 15:1.

The fat component of an infant formula can include small amount of oil contributed by non-vegetable components of the infant formula. For example, lipid can be contributed by skim milk or whey in the case of milk-based infant formulas. Similarly the fat component of an infant formula can include small amounts of sources of docosahexaenoic acid (DHA) and arachidonic acid (ARA) that may be added to provide nutritionally desirable amounts of DHA and ARA.

Breast milk lipid contains minor amounts of physiologically essential longer chain polyunsaturated fatty acids such as ARA and DHA. DHA is a longer chain polyunsaturated omega-3 fatty. ARA is a longer chain polyunsaturated omega-6 fatty acids. DHA can be formed in the body from linolenic acid, an 18-carbon omega-3 fatty acid. ARA can be formed in the body from linoleic acid, an 18-carbon omega-6 fatty acid. Infants appear to be unable to synthesize DHA and ARA at rates sufficient to meet their needs. Fat blends may be designed to provide these fatty acids now recognized as being critical for a normal rate of maturation of mental and visual development.

The amount of DHA in human breast milk lipid varies over a relatively wide range depending upon the composition of the diet. The amount of ARA is less variable. See, for example, Sauerwald et al. (Polyunsaturated fatty acid supply with human milk. Lipids 36(9):991-996, 2001). The amount by weight of total fatty acids as DHA in the milk fat of women in various populations is 0.14% to 1.4%. The amount by weight of total fatty acids as ARA in the milk fat of women in various populations is 0.3% to 0.9%. The present invention can provide, in various embodiments, a fat blend containing an amount by weight of total fatty acids as DHA of not less than 0.2% and not more than 2% and an amount by weight of total fatty acids as ARA of not less than 0.4% and not more than 2%.

Sources of DHA and ARA are known to those skilled in the art. Egg yolk is a source of both ARA and DHA. Egg yolk contains approximately 50% lipid on a dry weight basis. An infant formula may be made with egg yolk as a fatty ingredient (Zoller, U.S. Pat. No. 1,646,228). An infant formula may be made with egg yolk lipid (Clandinin et al., U.S. Pat. No. 4,670,285), separated egg yolk phospholipid, also known as egg lecithin, (Carlson et al., U.S. Pat. No. 6,080,787; Borror et al., U.S. Pat. No. 6,036,992) or synthetic triglyceride made with egg yolk fatty acids (Mazer et al., U.S. Pat. No. 6,200,624). It is known to those skilled in poultry science that the amounts and proportions of ARA and DHA in egg yolk can be managed by dietary manipulation. See, for example, Scheideler (U.S. Pat. No. 5,897,890) or Pilgrim et al. (U.S. Pat. No. 6,103,276).

Infant formula optionally may be enriched with respect to ARA by using certain oils from microorganisms (see, for example, Kyle, U.S. Pat. No. 5,658,767). Infant formula optionally may be enriched with respect to DHA by adding fish oil (Clandinin et al., U.S. Pat. No. 4,670,285), oil isolated from algae (Kyle et al., U.S. Pat. No. 5,492,938) or oil isolated from other single-cell organisms (see, for example, Barclay, U.S. Pat. No. 5,656,319). The source of DHA and ARA may be a blend such as disclosed by Kyle (U.S. Pat. No. 5,550,156), available from Martek Biosciences, Columbia, Md., USA.

Human milk fat invariably contains less than 9% by weight of stearic acid. Stearic acid is less soluble and less digestible than palmitic acid. The amounts of stearic acid in the heretofore described embodiments of the present invention do not exceed 5% by weight of total fatty acids.

The infant formulas of the present invention may take the forms of a powdered product, a concentrated liquid or a ready-to-feed product. Powder and concentrated liquid forms of infant formula require addition of water prior to feeding to an infant in accordance with the manufacturer's instructions.

The infant formula of the present invention can also contain sources of protein as is listed in the Codex Standard (Codex Standard for infant formula. CODEX STAN 72-1981 (amended 1983, 1985, 1987). Food and Agriculture Organization of the United Nations—World Health Organization. Rome, 1994). Such proteins can include proteins of bovine milk origin, such as skim milk, demineralized whey, whey protein concentrate, hydrolyzed milk proteins, lactic peptides and mixtures thereof. The proteins can also be of vegetable origin, such as isolated soy protein.

The infant formula can also contain carbohydrate to satisfy the infant's immediate needs for energy and such carbohydrates can include monosaccharides, disaccharides, oligosaccharides and polysaccharides (Fomon, Nutrition of Normal Infants. Mosby: St. Louis, 1993; pp. 176-191).

Other types of components that can be included in various embodiments of the infant formula are emulsifiers such as soy lecithin, monoglycerides, diglycerides, and the like.

One or more vitamins can be included in the infant formulas of the present invention. Such vitamins can be fat-soluble vitamins or water soluble vitamins including, but not limited to vitamin A, vitamin D, vitamin E, Vitamin C, Folic Acid, Thiamine, Riboflavin, Niacin, Vitamin B₆, Vitamin B₁₂, Biotin, Pantothenic Acid, Vitamin K, or combinations thereof. Reference to “vitamin” in the singular herein is intended to include the plural form of the term, i.e. one or more vitamins unless otherwise stated.

Other biologically important components that can be included are carotenoids; antioxidants, such as tocopherols, L-ascorbyl palmitate and the like.

The infant formula can also include mineral/electrolyte components such as, for example, calcium, sodium, potassium, phosphorus, iron, magnesium, copper, zinc, manganese, selenium, iodine, chloride or combinations thereof. Reference to “mineral” and/or “electrolyte” in the singular herein is intended to include the plural form of the term, i.e. one or more minerals and/or electrolytes unless otherwise stated.

Preferred embodiments of the invention are described in the following examples. Other embodiments within the scope of the claims herein will be apparent to one skilled in the art from consideration of the specification or practice of the invention as disclosed herein. It is intended that the specification, together with the examples, be considered exemplary only, with the scope and spirit of the invention being indicated by the claims which follow the examples.

### EXAMPLE 1

This example illustrates typical embodiments of the fat composition of the present invention.

Tables 4, 5 and 6 below show embodiments A-T by percent composition and resultant fatty acid profile.

TABLE 4
Embodiments of the fat composition (% by weight) and fatty acid profile

| | A | B | C | D | E | F | G |
|---|---|---|---|---|---|---|---|
| oleic acid oil | | | | | | | |
| HO safflower oil | 56% | | | 45% | 30% | | 50% |
| HO sunflower oil | | 55% | 45% | | | 50% | |
| Canola oil | 10% | 10% | 20% | | | | |
| HO soybean oil | | | | 20% | 30% | | |
| HO canola oil | | | | | | 10% | 15% |
| other oils included | | | | | | | |
| Coconut oil | 31% | 32% | 32% | 32% | 37% | 37% | 32% |
| ARA + DHA oil | 3% | 3% | 3% | 3% | 3% | 3% | 3% |
| fatty acid profile, % | | | | | | | |
| Lauric acid | 14.7 | 15.1 | 15.1 | 15.1 | 17.5 | 17.5 | 15.1 |
| Palmitic acid | 6.4 | 6.0 | 6.0 | 6.8 | 7.3 | 6.4 | 6.5 |
| Stearic acid | 2.3 | 3.3 | 3.1 | 2.6 | 2.7 | 3.2 | 2.3 |
| Oleic acid | 50.3 | 52.7 | 51.0 | 52.7 | 50.2 | 50.5 | 51.3 |
| Linoleic acid (LA) | 12.2 | 8.3 | 9.3 | 8.8 | 6.6 | 6.7 | 10.4 |
| Linolenic acid (ALA) | 1.2 | 1.0 | 1.9 | 1.0 | 1.3 | 0.8 | 1.2 |
| Ratio: LA/ALA | 10.3 | 8.2 | 5.0 | 9.0 | 5.2 | 8.9 | 8.6 |
| DHA | 0.27 | 0.27 | 0.27 | 0.27 | 0.27 | 0.27 | 0.27 |
| ARA | 0.74 | 0.74 | 0.74 | 0.74 | 0.74 | 0.74 | 0.74 |

TABLE 5
Additional embodiments of the fat composition (% by weight) and fatty
acid profile.

| | H | J | K | L | M | N |
|---|---|---|---|---|---|---|
| oleic acid oils | | | | | | |
| High oleic safflower | 55% | | | | | |
| High oleic sunflower | | 45% | | | 40% | |
| Canola | 10% | | | | 15% | |
| High oleic soybean | | | 52.5% | | | 35% |
| High oleic canola | | 15% | | 35% | | |
| Mid-oleic sunflower | | | | 35% | 10% | 30% |
| other oils included | | | | | | |
| Palm kernel oil | 32% | 32% | 32% | 27% | 32% | 32% |
| Normal safflower oil | | | 12.5% | | | |
| Normal sunflower oil | | 5% | | | | |
| Normal soy oil | | | | | | |
| ARA + DHA oil | 3% | 3% | 3% | 3% | 3% | 3% |
| fatty acid profile, % | | | | | | |
| Lauric acid | 15.9 | 15.9 | 15.9 | 13.4 | 15.9 | 15.9 |
| Palmitic acid | 6.1 | 6.0 | 7.3 | 4.4 | 5.3 | 5.4 |
| Stearic acid | 2.2 | 3.1 | 2.9 | 1.3 | 2.6 | 2.0 |
| Oleic acid | 51.9 | 53.3 | 50.3 | 52.2 | 52.1 | 51.9 |
| Linoleic acid (LA) | 12.0 | 9.9 | 11.7 | 14.1 | 10.9 | 10.6 |
| Linolenic acid (ALA) | 1.2 | 1.0 | 1.9 | 2.2 | 1.4 | 1.3 |
| Ratio: LA/ALA | 10.5 | 9.7 | 6.2 | 6.4 | 7.7 | 8.1 |
| DHA | 0.27 | 0.27 | 0.27 | 0.27 | 0.27 | 0.27 |
| ARA | 0.74 | 0.74 | 0.74 | 0.74 | 0.74 | 0.74 |

TABLE 6
Additional embodiments of the fat composition (% by weight) and fatty
acid profile.

| | P | Q | R | S | T |
|---|---|---|---|---|---|
| oleic acid oils | 54% | 56% | 53% | 58% | 55% |
| High oleic sunflower | | | | | |
| other oils included | | | | | |
| Palm kernel oil | 30% | 32% | 26% | | |
| Coconut oil | | | | 30% | 24% |
| Normal soy oil | 13% | 9% | 18% | 9% | 18% |
| ARA + DHA oil | 3% | 3% | 3% | 3% | 3% |
| fatty acid profile, % | | | | | |
| Lauric acid | 14.9 | 15.9 | 12.9 | 14.2 | 11.3 |
| Palmitic acid | 6.4 | 6.3 | 6.6 | 6.5 | 6.8 |
| Stearic acid | 3.4 | 3.4 | 3.5 | 3.5 | 3.6 |
| Oleic acid | 50.5 | 51.5 | 50.4 | 50.7 | 50.0 |
| Linoleic acid (LA) | 13.2 | 11.3 | 15.7 | 11.4 | 15.8 |
| Linolenic acid (ALA) | 1.1 | 0.8 | 1.5 | 0.8 | 1.5 |
| Ratio: LA/ALA | 11.9 | 13.9 | 10.5 | 13.6 | 10.4 |
| DHA | 0.27 | 0.27 | 0.27 | 0.27 | 0.27 |
| ARA | 0.74 | 0.74 | 0.74 | 0.74 | 0.74 |

### EXAMPLE 2

This example illustrates the preparation of an infant formula of the present invention.

A nutritionally complete infant formula comprising embodiment C of Table 4 can be prepared in the following manner to yield a 100 kg batch of infant formula powder, employing the ingredients and amounts listed below.

| Ingredient | Amount | |
|---|---|---|
| Lactose | 42.6 | kg |
| High oleic sunflower oil | 12.87 | kg |
| Coconut oil | 9.15 | kg |
| Canola (low erucic rapeseed) oil | 5.72 | kg |
| ARA + DHA oil | 0.86 | kg |
| Lecithin concentrate | 0.29 | kg |
| Ascorbyl palmitate | 7.8 | g |
| Fat-soluble vitamin premix | to meet label claims | |
| Sweet whey protein concentrate | 11.80 | kg |
| (50% protein) | | |
| Milk solids, non-fat (37% protein) | 15.95 | kg |

| | |
|---|---|
| Water-soluble vitamin premix | to meet label claims |
| Choline chloride | to meet label claims |
| Inositol | to meet label claims |
| Taurine | to meet label claims |
| Nucleotides | to meet label claims |
| Minerals | to meet label claims |

The four oil ingredients are blended together in a separate vessel and warmed to 115° F. The lecithin concentrate, ascorbyl palmitate and fat-soluble vitamin premix are dissolved in the oil.

The lactose is dissolved in water and heated to 140°-150° F. The warmed oil blend is then added to the lactose solution. A quantity of condensed skim milk to provide the amount of milk solids non-fat indicated is warmed to 150°-155° F. and added to the foregoing mixture with thorough mixing. The temperature of the mixture is then adjusted to within the range of 140°-155° F. and the sweet whey protein concentrate is incorporated therein. The mixture is neutralized to pH 6.6-6.9 and the remaining ingredients are then added thereto. Water-soluble vitamins, minerals, taurine, choline and inositol ingredients are added in sufficient amounts to provide the following amounts of vitamin and minerals per 100 g. of product.

| | | | |
|---|---|---|---|
| Vitamin A, IU | 1560 | Choline, mg | 39 |
| Vitamin D, IU | 312 | Inositol, mg | 23 |
| Vitamin B, IU | 7.8 | Calcium, mg | 360 |
| Vitamin C, mg | 43 | Phosphorus, mg | 240 |
| Folic Acid, mcg | 39 | Iodine, mcg | 35 |
| Thiamine, mg | 0.39 | Iron, mg | 9.4 |
| Riboflavin, mg | 0.47 | Magnesium, mg | 35 |
| Niacin, mg | 6.2 | Copper, mg | 0.3 |
| Vit. B. sub. 6, mg | 0.3 | Zinc, mg | 3 |
| Vit. B. sub. 12, mcg | 1.2 | Manganese, mcg | 27 |
| Biotin, mcg | 12 | Sodium, mg | 144 |
| Pantothenic Acid, mg | 2.3 | Potassium, mg | 540 |
| Vitamin K, mcg | 47 | Chloride, mg | 350 |
| Taurine, mg | 39 | Selenium, mcg | 23 |

The mixture is then pumped through a homogenizing apparatus, heated to 175° F. and spray dried to provide a powder containing 2-4% moisture.

The foregoing dry composition is then constituted with water at the rate of 128 g. thereof per liter of formula to provide a nutritionally complete dietary product suitable for feeding to infants as the sole item of diet.

All references cited in this specification are hereby incorporated by reference. The discussion of the references herein is intended merely to summarize the assertions made by their authors and no admission is made that any of the references or statements therein constitute prior art relevant to patentability. Applicants reserve the right to challenge the accuracy and pertinency of the cited references.

What is claimed is:

1. A fat composition suitable for use in an infant formula, said fat composition comprising:
(a) oleic acid in an amount of at least about 50% by weight of total fatty acids;
(b) lauric acid in an amount of at least about 10% by weight of total fatty acids; and
(c) palmitic acid in an amount of not more than about 10% by weight of total fatty acids.

2. A fat composition according to claim 1, which is in an acceptable infant food preparation.

3. A fat composition according to claim 1, which further comprises linoleic acid in an amount of at least about 5% and not more than about 16% by weight.

4. A fat composition according to claim 3, which further comprises linolenic acid in an amount of at least about 0.5% and not more than about 3.5% by weight.

5. A fat composition according to claim 4, wherein the ratio of linoleic acid to linolenic acid is at least about 5:1 and not more than about 15:1 by weight.

6. A fat composition according to claim 5, wherein the ratio of linoleic acid to linolenic acid is about 10:1 by weight.

7. A fat composition according to claim 1, which further comprises docosahexaenoic acid in an amount of at least about 0.2% and not more than about 2% by weight.

8. A fat composition according to claim 1, which further comprises arachidonic acid in an amount of at least about 0.4% and not more than about 2% by weight.

9. An infant formula comprising a fat composition of claim 1.

10. An infant formula according to claim 9, which is in a liquid form.

11. An infant formula according to claim 9, which is in powder form for reconstitution upon addition of an aqueous liquid.

12. An infant formula according to claim 9, wherein the fat composition further comprises linoleic acid in an amount of at least about 5% and not more than about 16% by weight.

13. An infant formula according to claim 9, wherein the fat composition further comprises linolenic acid in an amount of at least about 0.5% and not more than about 3.5% by weight.

14. An infant formula according to claim 13, wherein the ratio of linoleic acid to linolenic acid is at least about 5:1 and not more than about 15:1 by weight.

15. An infant formula according to claim 14, wherein the ratio of linoleic acid to linolenic acid is about 10:1 by weight.

16. An infant formula according to claim 9, wherein the fat composition further comprises docosahexaenoic acid in an amount of at least about 0.2% and not more than about 2% by weight.

17. An infant formula according to claim 9, which further comprises arachidonic acid in an amount of at least about 0.4% and not more than about 2% by weight.

18. An infant formula according to claim 9, which further comprises protein of bovine milk origin or protein of vegetable origin.

19. An infant formula according to claim 18, wherein the protein of bovine milk origin is selected from the group consisting of skim milk, demineralized whey, whey protein concentrate, hydrolyzed milk proteins, lactic peptides and mixtures thereof.

20. An infant formula according to claim 18, wherein the protein of vegetable origin is soy protein.

21. An infant formula according to claim 9, which further comprises carbohydrate selected from the group consisting of monosaccharides, disaccharides, oligosaccharides, polysaccharides, and combinations thereof.

22. An infant formula according to claim 9, which further comprises one or more of a component selected from the group consisting of a vitamin, a mineral or electrolyte, choline chloride, inositol, taurine, a nucleotide, and combinations thereof.

23. An infant formula according to claim 22, wherein the vitamin is selected from the group consisting of vitamin A, vitamin D, vitamin E, Vitamin C, Folic Acid, Thiamine, Riboflavin, Niacin, Vitamin B₆, Vitamin B₁₂, Biotin, Pantothenic Acid, Vitamin K, and combinations thereof.

24. An infant formula according to claim 22, wherein the mineral or electrolyte is selected from the group consisting of calcium, sodium, potassium, phosphorus, iron, magnesium, copper, zinc, manganese, selenium, iodine, chloride, and combinations thereof.

25. A substantially vegetable fat composition suitable for use in an infant formula, said fat composition comprising:
(a) oleic acid in an amount of at least about 50% by weight of total fatty acids; and
(b) lauric acid in an amount of at least about 10% by weight of total fatty acids.

26. A substantially vegetable fat composition according to claim 25, which further comprises palmitic acid in an amount of not more than about 10% by weight of total fatty acids.

27. A fat composition according to claim 25, which is in an acceptable infant food preparation.

28. A fat composition according to claim 25, which further comprises linoleic acid in an amount of at least about 5% and not more than about 16% by weight.

29. A fat composition according to claim 28, which further comprises linolenic acid in an amount of at least about 0.5% and not more than about 3.5% by weight.

30. A fat composition according to claim 29, wherein the ratio of linoleic acid to linolenic acid is at least about 5:1 and not more than about 15:1 by weight.

31. A fat composition according to claim 30, wherein the ratio of linoleic acid to linolenic acid is about 10:1 by weight.

32. A fat composition according to claim 25, which further comprises docosahexaenoic acid in an amount of at least about 0.2% and not more than about 2% by weight.

33. A fat composition according to claim 25, which further comprises arachidonic acid in an amount of at least about 0.4% and not more than about 2% by weight.

34. An infant formula comprising a substantially vegetable fat composition of claim 25.

35. An infant formula according to claim 34, which is in a liquid form.

36. An infant formula according to claim 34, which is in powder form for reconstitution upon addition of an aqueous liquid.

37. An infant formula according to claim 34, wherein the fat composition further comprises linoleic acid in an amount of at least about 5% and not more than about 16% by weight.

38. An infant formula according to claim 37, wherein the fat composition further comprises linolenic acid in an amount of at least about 0.5% and not more than about 3.5% by weight.

39. An infant formula according to claim 38, wherein the ratio of linoleic acid to linolenic acid is at least about 5:1 and not more than about 15:1 by weight.

40. An infant formula according to claim 39, wherein the ratio of linoleic acid to linolenic acid is about 10:1 by weight.

41. An infant formula according to claim 34, wherein the fat composition further comprises docosahexaenoic acid in an amount of at least about 0.2% and not more than about 2% by weight.

42. An infant formula according to claim 34, which further comprises arachidonic acid in an amount of at least about 0.4% and not more than about 2% by weight.

43. An infant formula according to claim 34, which further comprises protein of bovine milk origin or protein of vegetable origin.

44. An infant formula according to claim 43, wherein the protein of bovine milk origin is selected from the group consisting of skim milk, demineralized whey, whey protein concentrate, hydrolyzed milk proteins, lactic peptides and mixtures thereof.

45. An infant formula according to claim 43, wherein the protein of vegetable origin is soy protein.

46. An infant formula according to claim 34, which further comprises carbohydrate selected from the group consisting of monosaccharides, disaccharides, oligosaccharides, polysaccharides, and combinations thereof.

47. An infant formula according to claim 34, which further comprises one or more of each of components selected from the group consisting of a vitamin, a mineral or electrolyte, choline chloride, inositol, taurine, a nucleotide, and combinations thereof.

48. An infant formula according to claim 47, wherein the vitamin is selected from the group consisting of vitamin A, vitamin D, vitamin E, Vitamin C, Folic Acid, Thiamine, Riboflavin, Niacin, Vitamin B₆, Vitamin B₁₂, Biotin, Pantothenic Acid, Vitamin K, and combinations thereof.

49. An infant formula according to claim 47, wherein the mineral or electrolyte is selected from the group consisting of calcium, sodium, potassium, phosphorus, iron, magnesium, copper, zinc, manganese, selenium, iodine, chloride, and combinations thereof.

50. A fat composition of at least three fatty acid oils suitable for use in an infant formula, said fat composition comprising (a) at least about 50% by weight, total oleic acid oils comprising one or more oleic acid oils; and (b) not more than about 18% by weight, total linoleic acid oils comprising one or more linoleic acid oils.

51. A fat composition according to claim 50, further comprising at least about 20% by weight, total lauric acid oils comprising one or more lauric acid oils.

52. A fat composition according to claim 50 wherein the one or more oleic acid oils are selected from the group consisting of high oleic safflower oil, high oleic sunflower oil, mid-oleic sunflower oil, olive oil, canola oil, high oleic canola oil, high oleic low linolenic acid canola oil, high oleic soybean oil and combinations thereof.

53. A fat composition according to claim 52, wherein the oleic acid oils are high oleic safflower oil and high oleic canola oil.

54. A fat composition according to claim 52, wherein the oleic acid oils are high oleic safflower oil and high oleic soybean oil.

55. A fat composition according to claim 52, wherein the oleic acid oils are high oleic sunflower oil and high oleic canola oil.

56. A fat composition according to claim 52, wherein the oleic acid oils are high oleic sunflower oil and canola oil.

57. A fat composition according to claim 52, wherein the oleic acid oils are high oleic sunflower oil and high oleic soybean oil.

58. A fat composition according to claim 51, wherein the one or more lauric acid oils are selected from the class consisting of coconut oil, palm kernel oil, babassu oil, cuphea oil, and combinations thereof.

59. A fat composition according to claim 58, wherein the lauric acid oil is coconut oil.

60. A fat composition according to claim 58, wherein the lauric acid oil is palm kernel oil.

61. A fat composition according to claim 50, wherein the one or more linoleic acid oils are selected from the class consisting of soybean oil, corn oil, sunflower oil, safflower oil, linola oil, and combinations thereof.

62. A fat composition according to claim 61, wherein the linoleic acid oil is soybean oil.

63. A fat composition according to claim 51, wherein said fat composition comprises:
(a) 50% to 70% by weight of one or more oleic acid oils;
(b) 20% to 40% by weight of one or more lauric acid oils; and
(c) up to 15% by weight of one or more linoleic acid oils.

64. A fat composition according to claim 51, wherein said fat composition comprises:
(a) 55% by weight of high oleic sunflower oil;
(b) 10% by weight of canola oil; and
(c) 30% to 35% by weight of coconut oil.

65. A fat composition according to claim 51, wherein said fat composition comprises:
(a) 45% by weight of high oleic sunflower oil;
(b) 20% by weight of high oleic soybean oil; and
(c) 30% to 35% by weight of coconut oil.

66. A fat composition according to claim 51, wherein said fat composition comprises:
(a) 54% by weight of high oleic sunflower oil;
(b) 30% to 35% by weight of palm kernel oil; and
(c) 13% by weight of soybean oil.

67. An infant formula comprising the fat composition of claim 51.

68. An infant formula according to claim 67, which is in a liquid form.

69. An infant formula according to claim 67, which is in powder form for reconstitution upon addition of an aqueous liquid.

70. An infant formula according to claim 67, which further comprises protein of bovine milk origin or protein of vegetable origin.

71. An infant formula according to claim 70, wherein the protein of bovine milk origin is selected from the group consisting of skim milk, demineralized whey, whey protein concentrate, hydrolyzed milk proteins, lactic peptides, and mixtures thereof.

72. An infant formula according to claim 70, wherein the protein of vegetable origin is soy protein.

73. An infant formula according to claim 67, which further comprises carbohydrate selected from the group consisting of monosaccharides, disaccharides, oligosaccharides, polysaccharides, and combinations thereof.

74. An infant formula according to claim 67, which further comprises one or more of each of components selected from the group consisting of a vitamin, a mineral or electrolyte, choline chloride, inositol, taurine, a nucleotide, and combinations thereof.

75. An infant formula according to claim 74, wherein the vitamin is selected from the group consisting of vitamin A, vitamin D, vitamin E, Vitamin C, Folic Acid, Thiamine, Riboflavin, Niacin, Vitamin B₆, Vitamin B₁₂, Biotin, Pantothenic Acid, Vitamin K, and combinations thereof.

76. An infant formula according to claim 74, wherein the mineral or electrolyte is selected from the group consisting of calcium, sodium, potassium, phosphorus, iron, magnesium, copper, zinc, manganese, selenium, iodine, chloride and combinations thereof.

77. A method of making a fat composition suitable for use in an infant formula, said method comprising combining three or more fatty acid oils to produce a mixture comprising:
(a) oleic acid in an amount of at least about 50% by weight of total fatty acids;
(b) lauric acid in an amount of at least about 10% by weight of total fatty acids; and
(c) palmitic acid in an amount of not more than about 10% by weight of total fatty acids.

78. A method according to claim 77, wherein the fat composition is in an acceptable infant food preparation.

79. A method according to claim 77, wherein the mixture further comprises linoleic acid in an amount of at least about 5% and not more than about 16% by weight.

80. A method according to claim 79, wherein the mixture further comprises linolenic acid in an amount of at least about 0.5% and not more than about 3.5% by weight.

81. A method according to claim 80, wherein the ratio of linoleic acid to linolenic acid is at least about 5:1 and not more than about 15:1 by weight.

82. A method according to claim 81, wherein the ratio of linoleic acid to linolenic acid is about 10:1 by weight.

83. A method according to claim 77, wherein the mixture further comprises docosahexaenoic acid in an amount of at least about 0.2% and not more than about 2% by weight.

84. A method according to claim 77, which further comprises arachidonic acid in an amount of at least about 0.4% and not more than about 2% by weight.

85. A method for making an infant formula, the method comprising combining the mixture of claim 77 with one or more protein sources, one or more carbohydrates and one or more of a component selected from the group consisting of a vitamin, a mineral or electrolyte, choline chloride, inositol, taurine, a nucleotide, and combinations thereof.

86. A method according to claim 85, wherein the formula is in a liquid form.

87. A method according to claim 85, wherein the formula is in powder form for reconstitution upon addition of an aqueous liquid.

88. A method according to claim 85, wherein the mixture further comprises linoleic acid in an amount of at least about 5% and not more than about 16% by weight of the fat composition.

89. A method according to claim 88, wherein the mixture further comprises linolenic acid in an amount of at least about 0.5% and not more than about 3.5% by weight.

90. A method according to claim 89, wherein the ratio of linoleic acid to linolenic acid is at least about 5:1 and not more than about 15:1 by weight.

91. A method according to claim 90, wherein the ratio of linoleic acid to linolenic acid is about 10:1 by weight.

92. A method according to claim 85, wherein the fat composition further comprises docosahexaenoic acid in an amount of at least about 0.2% and not more than about 2% by weight.

93. A method according to claim 92, wherein the fat composition further comprises arachidonic acid in an amount of at least about 0.4% and not more than about 2% by weight.

94. A method according to claim 85, wherein the one or more protein sources comprise protein of bovine milk origin or protein of vegetable origin.

95. A method according to claim 94, wherein the protein of bovine milk origin is selected from the group consisting of skim milk, demineralized whey, whey protein concentrate, hydrolyzed milk proteins, lactic peptides and mixtures thereof.

96. A method according to claim 94, wherein the protein of vegetable origin is soy protein.

97. A method according to claim 85, wherein the one or more carbohydrates are selected from the group consisting of monosaccharides, disaccharides, oligosaccharides, polysaccharides, and combinations thereof.

98. A method according to claim 85, wherein the vitamin is selected from the group consisting of vitamin A, vitamin D, vitamin E, Vitamin C, Folic Acid, Thiamine, Riboflavin, Niacin, Vitamin B₆, Vitamin B₁₂, Biotin, Pantothenic Acid, Vitamin K, and combinations thereof.

99. A method according to claim 85, wherein the mineral or electrolyte is selected from the group consisting of calcium, sodium, potassium, phosphorus, iron, magnesium, copper, zinc, manganese, selenium, iodine, chloride, and combinations thereof.

100. A method of making a substantially vegetable fat composition suitable for use in an infant formula, said method comprising combining three or more fatty acid oils to produce a mixture comprising:
(a) oleic acid in an amount of at least about 50% by weight of total fatty acids; and
(b) lauric acid in an amount of at least about 10% by weight of total fatty acids.

101. A method according to claim 100, wherein the mixture further comprises palmitic acid in an amount of not more than about 10% by weight of total fatty acids.

102. A method according to claim 101, wherein the fat composition is in an acceptable infant food preparation.

103. A method according to claim 101, wherein the mixture further comprises linoleic acid in an amount of at least about 5% and not more than about 16% by weight.

104. A method according to claim 103, wherein the mixture further comprises linolenic acid in an amount of at least about 0.5% and not more than about 3.5% by weight.

105. A method according to claim 104, wherein the ratio of linoleic acid to linolenic acid is at least about 5:1 and not more than about 15:1 by weight.

106. A method according to claim 105, wherein the ratio of linoleic acid to linolenic acid is about 10:1 by weight.

107. A method according to claim 101, wherein the mixture further comprises docosahexaenoic acid in an amount of at least about 0.2% and not more than about 2% by weight.

108. A method according to claim 101, wherein the mixture further comprises arachidonic acid in an amount of at least about 0.4% and not more than about 2% by weight.

109. A method for making an infant formula, the method comprising combining the mixture of claim 100 with one or more protein sources, one or more carbohydrates and one or more of a component selected from the group consisting of a vitamin, a mineral or electrolyte, choline chloride, inositol, taurine, a nucleotide, and combinations thereof.

110. A method according to claim 109, wherein the formula is in a liquid form.

111. A method according to claim 109, wherein the formula is in powder form for reconstitution upon addition of an aqueous liquid.

112. A method according to claim 109, wherein the mixture further comprises linoleic acid in an amount of at least about 5% and not more than about 16% by weight of the fat composition.

113. A method according to claim 112, wherein the mixture further comprises linolenic acid in an amount of at least about 0.5% and not more than about 3.5% by weight.

114. A method according to claim 113, wherein the ratio of linoleic acid to linolenic acid is at least about 5:1 and not more than about 15:1 by weight.

115. A method according to claim 114, wherein the ratio of linoleic acid to linolenic acid is about 10:1 by weight.

116. A method according to claim 114, wherein the fat composition further comprises docosahexaenoic acid in an amount of at least about 0.2% and not more than about 2% by weight.

117. A method according to claim 114, wherein the fat composition further comprises arachidonic acid in an amount of at least about 0.4% and not more than about 2% by weight.

118. A method according to claim 109, wherein the one or more protein sources comprise protein of bovine milk origin or protein of vegetable origin.

119. A method according to claim 118, wherein the protein of bovine milk origin is selected from the group consisting of skim milk, demineralized whey, whey protein concentrate, hydrolyzed milk proteins, lactic peptides and mixtures thereof.

120. A method according to claim 118, wherein the protein of vegetable origin is soy protein.

121. A method according to claim 109, wherein the one or more carbohydrates are selected from the group consisting of monosaccharides, disaccharides, oligosaccharides, polysaccharides, and combinations thereof.

122. A method according to claim 109, wherein the vitamin is selected from the group consisting of vitamin A, vitamin D, vitamin E, Vitamin C, Folic Acid, Thiamine, Riboflavin, Niacin, Vitamin B₆, Vitamin B₁₂, Biotin, Pantothenic Acid, Vitamin K, and combinations thereof.

123. A method according to claim 116, wherein the mineral or electrolyte is selected from the group consisting of calcium, sodium, potassium, phosphorus, iron, magnesium, copper, zinc, manganese, selenium, iodine, chloride, and combinations thereof.

124. A method of making a fat composition suitable for use in an infant formula, said method comprising combining three or more fatty acid oils of which at least two are independently selected from the group consisting of oleic acid oils and linoleic acid oils, in a mixture to achieve:
(a) a concentration of total oleic acid oils of at least about 50%, by weight, of the mixture; and
(b) a concentration of total linoleic acid oils if present, in an amount of not more than about 18%, by weight, of the mixture.

125. A method according to claim 124, wherein at least one of the fatty acid oils is a lauric acid oil and wherein combining the fatty acid oils in the mixture achieves a concentration of total lauric acid oils of at least about 20% by weight of the mixture.

126. A method according to claim 125, wherein the oleic acid oils are selected from the group consisting of high oleic safflower oil, high oleic sunflower oil, mid-oleic sunflower oil, olive oil, canola oil, high oleic canola oil, high oleic low linolenic acid canola oil, and high oleic soybean oil.

127. A method according to claim 126, wherein the oleic acid oils are high oleic safflower oil and high oleic canola oil.

128. A method according to claim 126, wherein the oleic acid oils are high oleic safflower oil and high oleic soybean oil.

129. A method according to claim 126, wherein the oleic acid oils are high oleic sunflower oil and high oleic canola oil.

130. A method according to claim 126, wherein the oleic acid oils are high oleic sunflower oil and canola oil.

131. A method according to claim 126, wherein the oleic acid oils are high oleic sunflower oil and high oleic soybean oil.

132. A method according to claim 125, wherein the lauric acid oils are selected from the class consisting of coconut oil, palm kernel oil, babassu oil, and cuphea oil.

133. A method according to claim 132, wherein the lauric acid oil is coconut oil.

134. A method according to claim 132, wherein the lauric acid oil is palm kernel oil.

135. A method according to claim 124, wherein the linoleic acid oils are selected from the class consisting of soybean oil, corn oil, sunflower oil, safflower oil and linola oil.

136. A method according to claim 135, wherein the linoleic acid oil is soybean oil.

137. A method according to claim 125, wherein said fat composition comprises:
(a) 50% to 70% by weight of one or more oleic acid oils;
(b) 20% to 40% by weight of one or more lauric acid oils; and
(c) up to 15% by weight of one or more linoleic acid oils.

138. A method according to claim 125, wherein said fat composition comprises:
(a) 55% by weight of high oleic sunflower oil;
(b) 10% by weight of canola oil; and
(c) 30% to 35% by weight of coconut oil.

139. A method according to claim 125, wherein said fat composition comprises:
(a) 45% by weight of high oleic sunflower oil;
(b) 20% by weight of high oleic soybean oil; and
(c) 30% to 35% by weight of coconut oil.

140. A method according to claim 125, wherein said fat composition comprises:
(a) 54% by weight of high oleic sunflower oil;
(b) 13% to 35% by weight of palm kernel oil; and
(c) 15% by weight of soybean oil.

141. A method for making an infant formula, the method comprising combining the mixture of claim 125 with one or more protein sources, one or more carbohydrates and one or more of a component selected from the group consisting of a vitamin, a mineral or electrolyte, choline chloride, inositol, taurine, a nucleotide, and combinations thereof.

142. A method according to claim 141, wherein the formula is in a liquid form.

143. A method according to claim 141, wherein the formula is in powder form for reconstitution upon addition of an aqueous liquid.

144. A method according to claim 141, wherein the one or more protein sources comprise protein of bovine milk origin or protein of vegetable origin.

145. A method according to claim 144, wherein the protein of bovine milk origin is selected from the group consisting of skim milk, demineralized whey, whey protein concentrate, hydrolyzed milk proteins, lactic peptides and mixtures thereof.

146. A method according to claim 144, wherein the protein of vegetable origin is soy protein.

147. A method according to claim 141, wherein the one or more carbohydrates are selected from the group consisting of monosaccharides, disaccharides, oligosaccharides, polysaccharides, and combinations thereof.

148. A method according to claim 141, wherein the vitamin is selected from the group consisting of vitamin A, vitamin D, vitamin E, Vitamin C, Folic Acid, Thiamine, Riboflavin, Niacin, Vitamin B₆, Vitamin B₁₂, Biotin, Pantothenic Acid, Vitamin K, and combinations thereof.

149. A method according to claim 141, wherein the mineral or electrolyte is selected from the group consisting of calcium, sodium, potassium, phosphorus, iron, magnesium, copper, zinc, manganese, selenium, iodine, chloride, and combinations thereof.

150. A method for providing a fat component to an infant's diet, said method comprising feeding to the infant a formula comprising a fat composition comprising:
(a) oleic acid in an amount of at least about 50% by weight of total fatty acids;
(b) lauric acid in an amount of at least about 10% by weight of total fatty acids; and
(c) palmitic acid in an amount of not more than about 10% by weight of total fatty acids.

151. A method according to claim 150, wherein the fat composition further comprises linoleic acid in an amount of at least about 5% and not more than about 16% by weight.

152. A method according to claim 151, wherein the fat composition further comprises linolenic acid in an amount of at least about 0.5% and not more than about 3.5% by weight.

153. A method according to claim 152, wherein the ratio of linoleic acid to linolenic acid is at least about 5:1 and not more than about 15:1 by weight.

154. A method according to claim 153, wherein the ratio of linoleic acid to linolenic acid is about 10:1 by weight.

155. A method according to claim 150, wherein the fat composition further comprises docosahexaenoic acid in an amount of at least about 0.2% and not more than about 2% by weight.

156. A method according to claim 150, wherein the fat composition further comprises arachidonic acid in an amount of at least about 0.4% and not more than about 2% by weight.

157. A method according to claim 150, wherein the infant formula is in a liquid form.

158. A method according to claim 150, wherein the infant formula is in powder form for reconstitution upon addition of an aqueous liquid.

159. A method according to claim 150, wherein the infant formula further comprises protein of bovine milk origin or protein of vegetable origin.

160. A method according to claim 159, wherein the protein of bovine milk origin is selected from the group consisting of skim milk, demineralized whey, whey protein concentrate, hydrolyzed milk proteins, lactic peptides and mixtures thereof.

161. A method according to claim 159, wherein the protein of vegetable origin is soy protein.

162. A method according to claim 150, wherein the infant formula further comprises carbohydrate selected from the group consisting of monosaccharides, disaccharides, oligosaccharides, polysaccharides, and combinations thereof.

163. A method according to claim 150, wherein the infant formula further comprises one or more of a component selected from the group consisting of a vitamin, a mineral or electrolyte, choline chloride, inositol, taurine, a nucleotide, and combinations thereof.

164. A method according to claim 163, wherein the vitamin is selected from the group consisting of vitamin A, vitamin D, vitamin E, Vitamin C, Folic Acid, Thiamine, Riboflavin, Niacin, Vitamin B₆, Vitamin B₁₂, Biotin, Pantothenic Acid, Vitamin K, and combinations thereof.

165. A method according to claim 163, wherein the mineral or electrolyte is selected from the group consisting of calcium, sodium, potassium, phosphorus, iron, magnesium, copper, zinc, manganese, selenium, iodine, chloride, and combinations thereof.

166. A method for providing a fat component to an infant's diet, said method comprising feeding to the infant a formula comprising a substantially vegetable fat composition comprising:
(a) oleic acid in an amount of at least about 50% by weight of total fatty acids; and
(b) lauric acid in an amount of at least about 10% by weight of total fatty acids.

167. A method according to claim 166, wherein the fat composition further comprises palmitic acid in an amount of not more than about 10% by weight of total fatty acids.

168. A method according to claim 166, wherein the fat composition further comprises linoleic acid in an amount of at least about 5% and not more than about 16% by weight.

169. A method according to claim 168, wherein the fat composition further comprises linolenic acid in an amount of at least about 0.5% and not more than about 3.5% by weight.

170. A method according to claim 169, wherein the ratio of linoleic acid to linolenic acid is at least about 5:1 and not more than about 15:1 by weight.

171. A method according to claim 170, wherein the ratio of linoleic acid to linolenic acid is about 10:1 by weight.

172. A method according to claim 166, wherein the fat composition further comprises docosahexaenoic acid in an amount of at least about 0.2% and not more than about 2% by weight.

173. A method according to claim 166, wherein the fat composition further comprises arachidonic acid in an amount of at least about 0.4% and not more than about 2% by weight.

174. A method according to claim 166, wherein the infant formula is in a liquid form.

175. A method according to claim 166, wherein the infant formula is in powder form for reconstitution upon addition of an aqueous liquid.

176. A method according to claim 166, wherein the infant formula further comprises protein of bovine milk origin or protein of vegetable origin.

177. A method according to claim 176, wherein the protein of bovine milk origin is selected from the group consisting of skim milk, demineralized whey, whey protein concentrate, hydrolyzed milk proteins, lactic peptides and mixtures thereof.

178. A method according to claim 176, wherein the protein of vegetable origin is soy protein.

179. A method according to claim 166, wherein the infant formula further comprises carbohydrate selected from the group consisting of monosaccharides, disaccharides, oligosaccharides, polysaccharides, and combinations thereof.

180. A method according to claim 166, wherein the infant formula further comprises one or more of a component selected from the group consisting of a vitamin, a mineral or electrolyte, choline chloride, inositol, taurine, a nucleotide, and combinations thereof.

181. A method according to claim 180, wherein the vitamin is selected from the group consisting of vitamin A, vitamin D, vitamin E, Vitamin C, Folic Acid, Thiamine, Riboflavin, Niacin, Vitamin B₆, Vitamin B₁₂, Biotin, Pantothenic Acid, Vitamin K, and combinations thereof.

182. A method according to claim 180, wherein the mineral or electrolyte is selected from the group consisting of calcium, sodium, potassium, phosphorus, iron, magnesium, copper, zinc, manganese, selenium, iodine, chloride, and combinations thereof.

183. A method for providing a fat component to an infant's diet, said method comprising feeding to the infant a formula comprising a fat composition of at least three fatty acid oils said fat composition comprising (a) at least about 50% by weight, total oleic acid oils comprising of one or more oleic acid oils; and (b) not more than about 18% by weight, total linoleic acid oils comprising one or more linoleic acid oils.

184. A method according to claim 183, wherein the fat composition further comprises at least about 20% by weight, total lauric acid oils comprising one or more lauric acid oils.

185. A method according to claim 183 wherein the one or more oleic acid oils are selected from the group consisting of high oleic safflower oil, high oleic sunflower oil, mid-oleic sunflower oil, olive oil, canola oil, high oleic canola oil, high oleic low linolenic acid canola oil, and high oleic soybean oil.

186. A method according to claim 185, wherein the oleic acid oils are high oleic safflower oil and high oleic canola oil.

187. A method according to claim 185, wherein the oleic acid oils are high oleic safflower oil and high oleic soybean oil.

188. A method according to claim 185, wherein the oleic acid oils are high oleic sunflower oil and high oleic canola oil.

189. A method according to claim 185, wherein the oleic acid oils are high oleic sunflower oil and canola oil.

190. A method according to claim 185, wherein the oleic acid oils are high oleic sunflower oil and high oleic soybean oil.

191. A method according to claim 184, wherein the one or more lauric acid oils are selected from the class consisting of coconut oil, palm kernel oil, babassu oil and cuphea oil.

192. A method according to claim 191, wherein the lauric acid oil is coconut oil.

193. A method according to claim 191, wherein the lauric acid oil is palm kernel oil.

194. A method according to claim 183 wherein the one or more linoleic acid oils are selected from the class consisting of soybean oil, corn oil, sunflower oil, safflower oil, and linola oil.

195. A method according to claim 194, wherein the linoleic acid oil is soybean oil.

196. A method according to claim 184, wherein said fat composition comprises:
(a) 50% to 70% by weight of one or more oleic acid oils;
(b) 20% to 40% by weight of one or more lauric acid oils; and
(c) up to 15% by weight of one or more linoleic acid oils.

197. A method according to claim 184, wherein said fat composition comprises:
(a) 55% by weight of high oleic sunflower oil;
(b) 10% by weight of canola oil; and
(c) 30% to 35% by weight of coconut oil.

198. A method according to claim 184, wherein said fat composition comprises:
(a) 45% by weight of high oleic sunflower oil;
(b) 20% by weight of high oleic soybean oil; and
(c) 30% to 35% by weight of coconut oil.

199. A method according to claim 184, wherein said fat composition comprises:
(a) 52% by weight of high oleic sunflower oil;
(b) 30% to 35% by weight of palm kernel oil; and
(c) 15% by weight of soybean oil.

200. A method according to claim 183, wherein the infant formula is in a liquid form.

201. A method according to claim 183, wherein the infant formula is in powder form for reconstitution upon addition of an aqueous liquid.

202. A method according to claim 183, wherein the infant formula further comprises protein of bovine milk origin or protein of vegetable origin.

203. A method according to claim 202, wherein the protein of bovine milk origin is selected from the group consisting of skim milk, demineralized whey, whey protein concentrate, hydrolyzed milk proteins, lactic peptides and mixtures thereof.

204. A method according to claim 202, wherein the protein of vegetable origin is soy protein.

205. A method according to claim 183, wherein the infant formula further comprises carbohydrate selected from the group consisting of monosaccharides, disaccharides, oligosaccharides, polysaccharides, and combinations thereof.

206. A method according to claim 183, wherein the infant formula further comprises one or more of a component selected from the group consisting of a vitamin, a mineral or electrolyte, choline chloride, inositol, taurine, a nucleotide, and combinations thereof.

207. A method according to claim 206, wherein the vitamin is selected from the group consisting of vitamin A, vitamin D, vitamin E, Vitamin C, Folic Acid; Thiamine, Riboflavin, Niacin, Vitamin B₆, Vitamin B₁₂, Biotin, Pantothenic Acid, Vitamin K, and combinations thereof.

208. A method according to claim 206, wherein the mineral or electrolyte is selected from the group consisting of calcium, sodium, potassium, phosphorus, iron, magnesium, copper, zinc, manganese, selenium, iodine, chloride, and combinations thereof.
